(19) United States
(12) Patent Application Publication
(10) Pub. No.: US 2021/0376388 A1
(43) Pub. Date: Dec. 2, 2021

(54) METHOD FOR FORMING A 3D BATTERY WITH HORIZONTALLY-INTERDIGITATED ELECTRODES

(71) Applicant: Millibatt, Inc., Los Angeles, CA (US)

(72) Inventors: Guangyi Sun, Los Angeles, CA (US); Cheolwoong Lim, Los Angeles, CA (US); Leland Smith, Los Angeles, CA (US); Janet Hur, Los Angeles, CA (US)

(21) Appl. No.: 17/337,338

(22) Filed: Jun. 2, 2021

Related U.S. Application Data
(60) Provisional application No. 63/033,789, filed on Jun. 2, 2020.

(51) Int. Cl. H01M 10/0585; H01M 4/04

(52) U.S. Cl. CPC H01M 10/0585; H01M 4/0404; H01M 2220/30; H01M 4/0471; H01M 4/0419

(57) ABSTRACT

One variation of a method for forming a battery includes: fabricating an anode collector in a region of a conductive film over a substrate; fabricating a cathode collector, interdigitated with the anode collector, in the region of the conductive film; forming an anode coupon of an anode material over the region of the conductive film; ablating the anode coupon to selectively remove segments of the anode material from the anode coupon and to form a set of anode fins over the anode collector; forming an electrolyte film across the set of anode fins; and depositing a cathode material over the cathode collector and between adjacent anode fins in the set of anode fins to form an interdigitated cathode.

### CROSS-REFERENCE TO RELATED APPLICATIONS

This application claims the benefit of U.S. Provisional Patent Application No. 63/033,789, filed on 2 Jun. 2020, which is incorporated in its entirety by this reference.

This application is related to U.S. patent application Ser. No. 15/980,593, filed on 15 May 2018, and U.S. patent application Ser. No. 15/926,422, filed on 20 Mar. 2018, each of which is incorporated in its entirety by reference.

### TECHNICAL FIELD

This invention relates generally to the field of battery technologies and more specifically to a new and useful method for forming a 3D battery with horizontally-interdigitated electrodes in the field of battery technologies.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

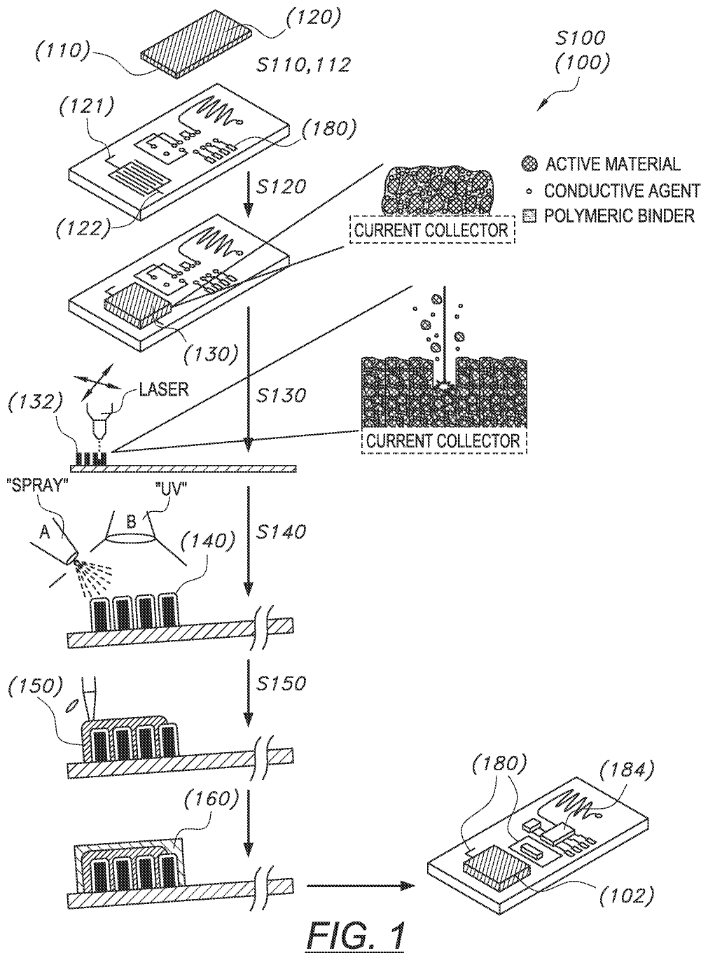

As shown in FIG. 1, a method S100 for forming a 3D battery includes: fabricating an anode collector 121 in a region of a conductive film 120 over a substrate 110 in Block S110; fabricating a cathode collector 122, interdigitated with the anode collector 121, in the region of the conductive film 120 in Block S112; forming an anode coupon 130 of an anode material over the region of the conductive film 120 in Block S120; ablating the anode coupon 130 to selectively remove segments of the anode material from the anode coupon 130 and form a set of anode fins 132 over the anode collector 121 in Block S130; forming an electrolyte film 140 across the set of anode fins 132 in Block S140; and depositing a cathode material over the cathode collector 122 and between adjacent anode fins 132 in the set of anode fins 132 to form an interdigitated cathode 150 in Block S150.

One variation of the method S100 includes: fabricating a first collector 121 in a region of a conductive film 120 over a substrate 110 in Block S110; fabricating a second collector 122, interdigitated with the first collector 121, in the region of the conductive film 120 in Block S112; forming a first electrode coupon of a first electrode material over the region of the conductive film 120 in Block S120; ablating the first electrode coupon to selectively remove segments of the first electrode material from the first electrode coupon and form a first set of electrode fins over the first collector 121 in Block S130; forming an electrolyte film 140 across the first set of electrode fins in Block S140; and depositing a second electrode material over the second collector 122 and between adjacent electrode fins in the first set of electrode fins to form an interdigitated second electrode in Block S150.

### 2. Applications

Generally, the method S100 can be executed to fabricate 3D microstructure electrodes for small batteries (e.g., between 0.5 and 5 millimeters in thickness). In particular, the method S100 can be executed in conjunction with a laser system to form interdigitated 3D battery electrodes characterized by high surface-area-to-volume ratios and short diffusion lengths, thereby: reducing path lengths for ions traveling between electrodes within the battery; increasing peak discharge current of the battery; and increasing energy density of the battery.

For example, Blocks of the method S100 can be executed to deposit, mold, cast, stamp, or otherwise apply a particulate anode material (e.g., an active material, a conductive agent, and a polymer binder) over a conductive or dielectric substrate no and to then selectively remove regions of the anode material to form an anode containing an array of anode fins 132 (e.g., straight rectangular fins, tapered fins, pyramidal fins, cylindrical posts) over the substrate 110. The anode fins 132 are then coated with an electrolyte material, and valleys between the electrolyte-coated anode fins 132 are filled with a cathode material to form an interdigitated cathode 150. The cathode and electrolyte are then wetted with solvated ions to complete the battery. The battery can then be: sealed within a package, such as inserted into a coin cell package 170 (as shown in FIG. 5), capped with a hermetic seal (e.g., via glass-flit bonding, diffusion bonding, or laser welding), and/or encased in potting material (as shown in FIG. 1).

The method S100 and resulting battery are described herein in the context of a horizontal electrode configuration with interdigitated anode and cathode fins extending laterally and fabricated over a common substrate 110. However, Blocks of the method S100 can also be executed to produce a battery containing a vertical electrode configuration with interdigitated anode and cathode fins extending vertically and stacked over a common substrate 110.

### 3. Substrate

Blocks S110 and S112 of the method S100 recite: fabricating an anode current collector in a region of a conductive film 120 over a substrate 110; and fabricating a cathode current collector, interdigitated with the anode current collector, in the region of the conductive film 120, respectively. Generally, in Blocks S110 and S112, the substrate no is fabricated to include two discrete, interdigitated traces that form interdigitated anode and cathode current collectors, respectively, and over which the anode and cathode are formed to complete a battery. In particular, the substrate no defines a base over which anode material is cast in Block S120 and subsequently machined to form a 3D anode structure in Block S130. The substrate 110 is also electrically-conductive or includes a conductive film 120 and thus functions as a current collector for the anode and a separate current collector for the adjacent cathode.

In one implementation, the substrate 110 includes a dielectric structure with patterned conductive traces, such as: a flexible PCB with a metallic (e.g., copper, silver, aluminum) film over a flexible polyimide, PEEK, or polyester backing; or a glass panel (e.g., a 500-micron-thick alkali-aluminosilicate pane) plated on one side with a chrome or copper film. In this implementation and as shown in FIG. 1, to form a horizontal battery with laterally-interdigitated anode and cathode fins, the metallic film of the substrate 110 can be patterned to form two discrete, electrically-isolated interdigitated conductive traces, including: an anode trace that approximates the plan section of the anode in Block S110; and a cathode trace that approximates the plan section of the cathode in Block S112. The anode trace can thus function as an anode current collector for the anode subsequently fabricated (e.g., laser-machined) over the substrate 110, and the cathode trace can similarly function as a cathode current collector for the cathode similarly fabricated (e.g., molded) over the substrate 110.

In this implementation, the substrate 110 can also include optical alignment features readable by the laser system (or other alignment (sub)system) to locate the substrate 110 relative to these anode and cathode traces in order to guide selective removal of anode material that falls over the cathode trace or that otherwise does not fall directly over the anode trace.

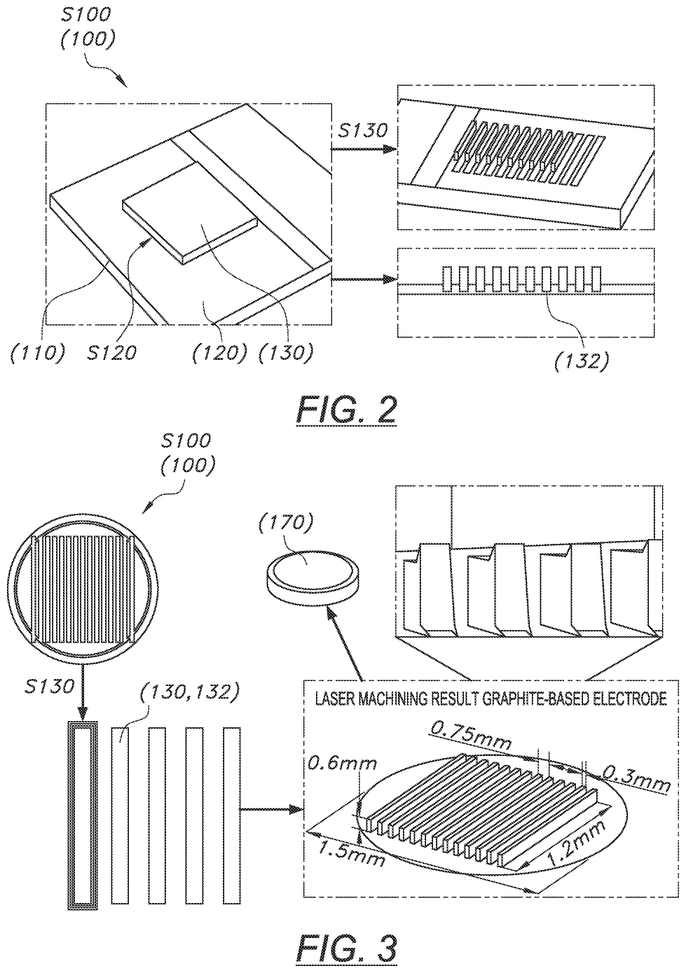

Furthermore, in one implementation, the substrate no defines an elongated rectangular footprint with a width less than its length such that the substrate no is subject (or “prone”) to greater bending moments and greater deflection about an axis parallel to the short sides of the substrate no. In this implementation, because the anode fins 132 may be more susceptible to fracture due to strain along their long axes, anode fin traces (and thus anode fins 132) can be fabricated over the substrate 110 with the long axes of the anode fin traces (and thus the long axes of the anode fins 132) parallel to the short sides of the substrate 110. More specifically, the substrate 110 can define an elongated rectangular structure and may therefore be more susceptible to bending about an axis parallel to the short sides of the substrate 110; and the anode fins 132 may be more robust to bending about an axis parallel to their long axes. Therefore, the anode fin traces can be fabricated on the substrate 110 to form footprints of the resulting anode fin 132 such that the anode fins 132 extend parallel to the short sides of the substrate 110, as shown in FIGS. 1 and 2. Deflection of the substrate 110 about its primary bending axis may therefore yield minimal stress gradients across the anode fins 132 and along junctions between the anode fins 132 and the substrate 110, thereby limiting opportunity for fracture, delamination, or other damage to the anode fins 132 when the substrate 110—or the resulting battery more generally—is bent (e.g., intentionally to form a curved battery during assembly) or (mis)handled.

For example, the method S100 can include: fabricating the anode collector 121 over the substrate 110—that defines a rectangular structure and a primary bending axis parallel to a short side of the rectangular structure—in Block S110 such that parallel vanes of the anode collector 121 extend parallel to the short side of the rectangular structure; and fabricating the set of anode fins 132 over the set of parallel vanes and extending parallel to the short side of the rectangular structure in Block S130.

### 4. Anode Material

In one implementation shown in FIG. 1, the anode material includes: between 88% and 92% (e.g., 90%) by weight active material predominantly between 5 and 10 microns in maximal dimension; between 7% and 9% (e.g., 8%) by weight conductive agent (e.g., carbon black) approximately 100 nanometers in maximal dimension; and between 1% and 3% (e.g., 2%) by weight polymer binder. Uncured anode material can also be mixed with a solvent to form a conductive anode slurry.

In this implementation, the polymer binder can burn or vaporize at a temperature (significantly) above processing and operating temperatures of the resulting battery and below a low temperature when ablated by the laser system. For example, the polymer binder can include carboxymethylcellulose or PVDF that burns at temperatures greater than 250° C.

### 5. Anode Coupon

Block S120 of the method S100 recites forming an anode coupon 130 of anode material over the region of the conductive film 120. Generally, in Block S120, the conductive anode slurry can be applied to the substrate 110 over the anode trace, such as by: stamping; molding; spraying; dipping; pipetting; 3D printing; or doctor blading. The conductive anode slurry can then be baked (e.g., in an oven or on a hot plate) or dried under vacuum or in open air to cure binder and form a solid, rigid anode coupon 130 over the substrate 110.

In one implementation, the conductive anode slurry is applied across the full width and length of the top face of the substrate 110 to form a continuous anode coupon 130 across the substrate 110. For example, the method S100 can include: applying a polymer film about the region of the conductive film 120 to form an anode coupon mask (e.g., photoresist applied via photolithography); mixing the anode materials (active material, conductive additive and binder) with a solvent to form an anode slurry; applying the anode slurry across the anode coupon mask and exposed regions of the conductive film 120; and drying the anode slurry to form the anode coupon 130 in Block S120. This anode coupon 130 and substrate 110 assembly are then processed as described below to selectively remove anode material across the entire substrate 110 outside of target anode fin 132 locations (e.g., defined by the anode trace) in Block S130. In this example, the anode coupon mask can mask a second region of the substrate 110—adjacent the region of the conductive film 120 occupied by the anode fins 132—from swarf moving off of the anode coupon 130 during ablation in Block S130. Later, such as following formation of the electrolyte film 140 across the set of anode fins 132, the anode coupon mask can be removed from the conductive film 120.

In another implementation, an anode coupon mask—defining opens at target anode fin 132 locations—is applied to the top face of the substrate 110. For example, a polymer film can be sprayed or patterned over the top face of the substrate 110 to form the anode coupon mask. The anode slurry can then be sprayed, dipped, stamped, doctor bladed, or otherwise applied across the mask and exposed regions of the substrate 110. Once (or before) the anode slurry is dried or cured, the mask is removed from the substrate no—such as by peeling or chemical dissolution—to yield one or more discrete, individual anode coupons 130 on the substrate 110.

Alternatively, the mask can remain in place over the substrate 110 while an anode coupon 130 is processed by the laser system to form anode fins 132 such that the mask further protects unexposed regions of the substrate 110 from errant spoil or swarf ablated from the anode coupon 130. The mask can then be removed from the substrate 110 and from around the completed anode fins 132—such as by peeling or chemical dissolution—before or after electrolyte is applied to the anode(s).

### 6. Electrode Fin Machining

Block S130 of the method S100 recites ablating the anode coupon 130 to selectively remove anode material from the anode coupon 130 and form a set of anode fins 132 over the anode collector 121. Generally, in Block S130, the anode coupon 130 can be ablated with the laser system (or “laser-machined,” “laser-etched”) to selectively remove anode material from the anode coupon 130 to reveal the 3D fin microstructure of an anode, such as including: an array of elongated, parallel anode fins 132 coupled on one end to a common column (or “manifold”) extending perpendicular to the array of anode fins 132.

### 6.1 Laser System

In one implementation, the substrate 110 and anode coupon 130 assembly are processed in a low-heat spread laser in Block S130, such as an ultraviolet (or “UV”) laser that outputs high-frequency, short-duration, small-spot-size beam pulses of electromagnetic radiation at or near 355 nm, 515 nm, and/or 532 mm wavelengths in order to achieve rapid, very local heating of the anode material that burns or vaporizes binder in small, local volumes of anode material and thus disassociates local volumes of active material and conductive agent from the anode coupon 130. More specifically, in Block S130, the substrate 110 and anode coupon 130 assembly can be processed by a UV pulse-laser system to produce highly-localized heating over a very small spot size (e.g., a 20-micron-diameter spot) and at high pulse frequency to yield: low heat spread across the anode coupon 130 and thus minimal stress in the anode coupon 130 due to local temperature gradients; and minimal local melting, combustion, or vaporization of anode material outside of an incident beam pulse and thus high geometric fidelity of the resulting anode fins 132.

### 6.2 Laser Ablation

In Block S130, once the substrate 110 and anode coupon 130 are fixtured and aligned in the laser system, the laser system can scan the output of the laser (e.g., via a mirror) along a continuous tool path to selectively remove anode material—over a sequence of vertical steps—around each target anode fin 132 geometry to transform the anode coupon 130 into a complete array of anode fins 132 (e.g., within seconds), as shown in FIG. 3. Concurrently, the laser system can draw a vacuum over the substrate 110 and anode coupon 130 assembly in order to draw spoil, swarf, and/or other ablated particulate away from the assembly.

In one implementation, the substrate 110 can be (manually or automatically) positioned in the laser system to align alignment features—defined on the substrate 110 relative to the anode and cathode traces—to a reference feature of the laser system or with an offset value between these alignment features and the origin of the laser system measured and recorded. The laser system can then scan the laser output across the anode coupon 130 according to the tool path—defined relative to the reference feature of the laser system or offset from the origin of the laser system by the offset value—to selectively remove anode material that falls over the cathode trace or that otherwise does not fall directly over the anode trace.

In this implementation, the laser system can also machine regions of the anode coupon 130—outside of the anode trace—fully down to the substrate 110 and can further ablate the top surface of the substrate 110 in valleys between adjacent anode fins 132, thereby roughening the exposed surface of the substrate 110 and yielding improved adherence of the electrolyte and/or cathode material to the top surface of the substrate 110.

Alternatively, rather than machine anode fins 132 over a preprocessed substrate 110 that defines anode and cathode traces below the anode coupon 130 in Block S130, the laser system can instead: adjust laser output settings for removal of anode material from the anode coupon 130; scan the laser output according to a first tool path to remove anode material fully down to the substrate 110 and thus render the anode; adjust laser output settings for removal of the metallic film (e.g., a copper film for the anode collector; an aluminum film for the cathode collector; a stainless steel film for both the anode and cathode collectors); and scan the laser output according to a second tool path to remove conductive material from the exposed surface of the substrate 110 along bases of the anode fins 132 and thus separate and electrically isolate a cathode trace from an anode trace under the anode fins 132. More specifically, in this implementation, the laser system can: ablate the anode coupon 130 to remove anode outside of the target locations and geometry of anode fins 132 in the battery; and then ablate exposed conductive film 120 on the substrate 110 between these anode fins 132 in order to retroactively form both an anode trace under the anode fins 132 and a corresponding, interdigitated, electrically-isolated cathode trace. For example, after ablating the anode coupon 130 to form the anode fins 132 fully down to the substrate 110, the laser system can trace the laser output along the perimeter of the anode to remove conductive material on the substrate 110 along the perimeter of the anode, thereby forming offset, electrically-isolated, and interdigitated anode and cathode traces on the substrate 110.

In a similar example, the method S100 can include: forming the anode coupon 130 over the region of the conductive film 120 comprising a continuous conductive layer over the substrate 110 in Block S120; laser-machining the anode coupon 130 to remove anode material, from a top of the anode coupon 130 down to the continuous conductive layer, about bases of the set of anode fins 132 in Block S130; and laser-machining the continuous conductive layer down to the substrate 110 around bases of the set of anode fins 132 to conductively isolate the anode collector 121—located under the set of anode fins 132—from the cathode collector 122, which extends between adjacent pairs of anode fins 132 in the set of anode fins 132, in Blocks S110 and S112.

In one variation, multiple anode coupons 130 are formed at discrete locations over a larger substrate 110 in Block S120, and the laser system processes each of these anode coupons 130 to form multiple discrete anodes—each corresponding to one battery—over the larger substrate 110 in a single setup in Block S130. In a similar variation, a single anode coupon 130 is formed across a larger substrate 110, and the laser system processes this anode coupon 130 to form multiple discrete anodes—each corresponding to one battery—over the larger substrate no in a single setup. In this variation, before, while, or after forming multiple discrete anodes over the larger substrate no, the laser system can scan the laser output along perimeters of each battery represented in this larger substrate no in order to score or fully cut the substrate no along these discrete batteries. The scored substrate no can then be processed as described below to concurrently deposit electrolyte and cathode materials over each anode and to complete each battery on this larger substrate no; the larger substrate no can then be broken or tom along these score lines to separate these discrete batteries. Alternatively, once individual substrate no and anode sections are cut from the larger substrate no by the laser system, each substrate no and anode section can be individually processed as described below to form individual batteries.

Furthermore, FIGS. 1, 2, 3, and 5 depict the anode coupons 130 defining rectilinear and circular geometries. However, an anode coupon 130 can define any other geometry, such as: an annular ring; a silhouette of a logo or icon; an ellipse; a serpentine or boustrophedon structure; etc.

### 6.3 Draft

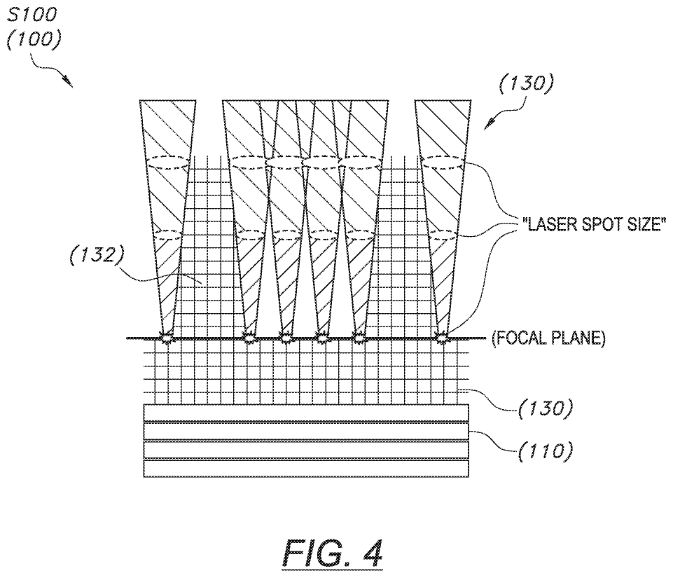

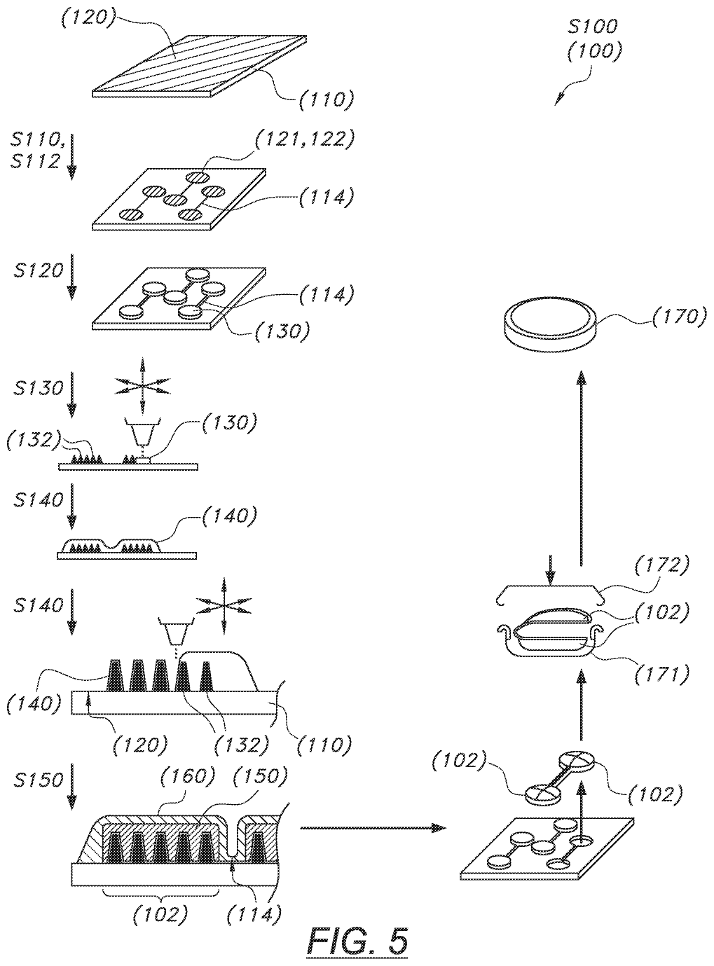

In one variation of the method S100 shown in FIG. 4, the laser is focused on the anode coupon 130 at increasing offset distances from the top perimeter of each fin at increasing machining depths in order to form anode fins 132 with drafted (e.g., 5°) sidewalls. Additionally or alternatively, the laser can be refocused to control the spot size of the laser beam and to focus energy on the anode coupon 130 at increasing machining depths in order to form anode fins 132 with drafted sidewalls.

For example, drafted (i.e., vertically-tapered) anode fins 132 may yield greater mechanical and visual access to sidewalls of these anode fins 132, thereby enabling more uniform deposition (e.g., spray coating), selective curing (e.g., via UV-exposure), and final thickness of an electrolyte coating applied over these anode fins 132. Similarly, drafted anode fins 132 may improve ease of filling interstitials between adjacent fins with cathode material (e.g., by pressing cathode material into these interstitials), as described below.

Therefore, in Block S130, the laser system can: scan a laser beam between adjacent anode fins 132, in the set of anode fins 132, over a sequence of tool paths; and focus the laser beam to a sequence of spot sizes decreasing in width for each subsequent tool path in the sequence of tool paths to form the set of anode fins 132 defining tapered geometries exhibiting positive draft over the substrate 110. (The laser system can also scan the laser beam between adjacent anode fins 132, in the set of anode fins 132, to remove anode material around bases of the set of anode fins 132 and to expose the conductive film 120 between adjacent anode fins 132, in the set of anode fins 132.)

### 7. Electrolyte

Block S140 of the method S100 recites forming an electrolyte film 140 across the set of anode fins 132. Generally, in Block S140, an electrolyte material can be applied over the anode fins 132 of the substrate 110 and anode assembly to form an electrolyte film 140 over the anode.

In one implementation, a UV-curable electrolyte material is sprayed onto the anode to form an electrolyte film 140 over the sides and tops of the anode and over the substrate no between the anode fins 132. For example, the electrolyte material can be mixed with a carrier solvent (e.g. 2-butanone) in the range of 10% to 50% by volume and discharged from a nozzle toward the anode and substrate 110. During this coating process, the nozzle can be traversed through a range of orientations relative to the substrate 110 (or vice versa) to yield a relatively consistent electrode film thickness (e.g., 50 microns±5 microns) across the anode and exposed region of the substrate 110. For example, the nozzle can generate a fine mist of electrolyte/solvent mixture: by introducing this liquid mixture into a stream of high-pressure gas; or via ultrasonic agitation. This mist can then be directed onto target regions of the anode fins 132 and substrate 110 via a second stream of gas directed toward these target regions.

The anode and the substrate 110 can additionally or alternatively be agitated (e.g., ultrasonically) during this coating process in order to improve fusion and dispersion of aerosol droplets across surfaces of the anode and the substrate 110.

In a similar example, the method S100 can include: mixing an electrolyte material with a carrier solvent to form an electrolyte slurry; during a coating process, discharging the electrolyte slurry from a nozzle toward the set of anode fins 132, traversing the nozzle through a range of orientations relative to the substrate 110 to coat the set of anode fins 132 and an exposed region of the substrate 110 with the electrolyte slurry approximating a consistent thickness, and ultrasonically agitating the substrate 110 relative to the nozzle; heating the substrate 110 to remove excess carrier solvent from the electrolyte slurry and thus form the electrolyte film 140 across the set of anode fins 132 and the exposed region of the substrate 110; and exposing the electrolyte film 140 to radiation to cure the electrolyte film 140 defining a continuous, rigid, thin-film, porous electrolyte across surfaces of the set of anode fins 132 and the substrate 110 in Block S140.

Alternatively, the anode and substrate 110 assembly can be dipped in an electrolyte-solvent bath to (substantially) uniformly coat the anode and the exposed regions of the substrate 110. The electrolyte film 140 can then be: heated (e.g., on a hotplate) to drive off excess solvent; selectively exposed to UV radiation (e.g., via stereolithography) to selectively cure the electrolyte film 140 over the sides and tops of the anode and sections of the exposed substrate 110 outside of the cathode trace; and washed in solvent to remove uncured electrolyte from over the cathode trace. The cured electrolyte film 140 can be further rinsed to remove a phase-separated polymer from the cured electrolyte film 140 to form a continuous, rigid, thin-film, porous electrolyte film 140 across surfaces of the anode and the substrate 110—outside of the cathode trace, as described in U.S. patent application Ser. No. 15/980,593—which can then accept solvated ions in a wetting step, as described below.

In a similar implementation, the UV-curable electrolyte material can be doctor-bladed or spin-coated onto the substrate 110 to fill voids between anode fins 132 and then selectively cured across surfaces of the anode and the substrate 110 outside of the cathode trace, such as according to methods and techniques described in U.S. patent application Ser. No. 15/980,593.

### 7.1 Overcoated Electrolyte

In one variation, excess electrolyte material is cured around the anode fins 132 and/or around the exposed substrate 110 between these anode fins 132, such as by fully exposing the electrode material applied across the anode and substrate 110 assembly or by selectively exposing this electrode material with an oversized photolithography mask. This cured electrolyte material is then further ablated with a laser—such as described above—to remove excess electrolyte material from around the anode fins 132 and substrate 110 to form an electrolyte of more uniform thickness and/or to fully remove excess electrolyte from the cathode trace. More specifically, in this variation, the substrate 110, anode, and electrolyte assembly can be processed according to methods and techniques described above to remove overcoated electrolyte material from the anode fins 132 and substrate 110—via laser-ablation—to yield a rigid electrolyte of uniform, controlled thickness over the anode.

For example, the method S100 can include: filling valleys between adjacent anode fins 132 in the set of anode fills with an electrolyte material; and ablating the electrolyte material to remove excess electrolyte material from around the set of anode fins 132 and the substrate 110 to render the electrolyte film 140 approximating a consistent thickness across the set of anode fins 132 in Block S140.

### 7.2 Laser-Curing Electrolyte

In another variation, after ablating the anode coupon 130 to form the anode fins 132 (and while the substrate 110 and anode assembly remain fixtured in the laser system), liquid electrolyte material is flowed over the anode and substrate 110. The laser system then: scans the output of the laser (e.g., electromagnetic radiation in the UV spectrum) across the substrate 110 and offset from the vertical surfaces of the anode fins 132; and focuses the output of the laser at decreasing depths along the anode fins 132 in order to selectively cure the electrolyte material over a sequence of steps up to the height of these anode fins 132.

Therefore, in this variation, the laser system can machine the anode coupon 130 to form the set of anode fins 132 and then selectively cure electrolyte material—subsequently flowed over these anode fins 132—to form a rigid electrolyte film 140 across these anode fins 132 while the substrate 110 remains fixtured in the laser system and/or within the same jig.

### 8. Cathode

Block S150 of the method S100 recites depositing a cathode material over the cathode collector 122 and between adjacent anode fins 132 in the set of anode fins 132 to form an interdigitated cathode 150. Generally, in Block S150, a cathode material can be applied over the substrate 110 and between the electrolyte-coated anode fins 132 of the anode to form a horizontally-interdigitated cathode 150 directly over the cathode trace.

In one implementation, a dry cathode material includes: active lithium (e.g., 90% by mass lithium-storing particles, such as LiCoO₂, NMC, or NCA); carbon (e.g., 7-8% by mass graphitic carbon and carbon black); and a binder (e.g., 2-3% by mass polyvinylidene difluoride (or “PVDF”)). (Alternatively, dry cathode material can include a gel, such as 3% polyethylene oxide and/or poly(methyl methacrylate) by mass in place of the binder.) For example, the cathode material can include: LiNi_{0.33}Mn_{0.33}CO_{0.33}O₂ or LiNi_{0.84}Co_{0.12}Al_{0.04}O₂. Once cured (or “dried”) around the anode, a volume of the cathode material can define a discrete, flexible, three-dimensional cathode that: extends horizontally between fins of the anodes; is offset from the anode by the electrolyte; and extends over and contacts the cathode trace on the substrate 110.

For example, valleys between adjacent anode fins 132 can be preloaded with a solvent (e.g., propylene carbonate) that dissolves the cathode material, such as with an automated liquid dispensing system (e.g., a computer-controlled liquid pipetting system). Alternatively, the solvent can be flowed over the substrate 110 to fill these valleys, and the substrate 110 can then be spun or doctor bladed to remove excess solvent down to a uniform height above the anode. In this example, a volume of wet cathode material (e.g., cathode material dissolved in the solvent) can then be similarly dispensed over solvent in each valley. Initially, the wet cathode material can float over the volume of solvent currently occupying the valleys between anode fins 132; over time, solids in the wet cathode material can flow downwardly (e.g., by gravity) into these valleys, thereby displacing solvent out of these valleys, such as described in U.S. patent application Ser. No. 15/926,422.

In another example, the cathode is mixed with a solvent to form a slurry (e.g., approximately 50% cathode solids and 50% solvent), which is then deposited over the electrolyte, backed with a plate, and pressed into and around cavities between the anode fins and electrolyte.

The cathode material can then be dried—such as in an oven—to drive off excess solvent and to thus form a solid, flexible cathode that extends horizontally between the anode fins 132.

### 9. Ions

The dried cathode and the electrolyte film 140 can then be wetted with solvated ions, which flow into the electrolyte film 140 to form a continuous, rigid, thin-film electrolyte between the anode and the cathode, thereby completing the battery internals. For example, ions and solvent can be pipetted over the interdigitated anode and cathode fins and these ions and solvent can wick into porous structures of the cathode and electrolyte to complete the battery internals.

### 10. Packaging

The substrate no, anode, electrolyte, and cathode assembly can then be packaged to complete the battery.

In one implementation, an electrically-insulative, thermally-conductive, and non-porous potting material is cast, molded, sprayed, or dip-coated over the substrate no to encase and seal the anode, electrolyte, and cathode assembly. In this implementation described above in which multiple anode coupons 130 are processed on a single, larger substrate 110, the substrate 110 can then be separated—such as by tearing, dicing, or laser-cutting the substrate 110 between adjacent battery cells 102—in order to form a set of discrete batteries.

In another implementation, once the cathode and electrolyte are wetted to complete the battery internals and once the substrate 110, anode, electrolyte, and cathode assembly is trimmed to size (e.g., by dicing or laser cutting), the assembly is enclosed in a sealed coin cell package 170, as shown in FIGS. 3 and 5.

More specifically, in this implementation, the method S100 can include: wetting the electrolyte film 140 with solvated ions to activate the electrolyte film 140; loading the battery cell 102 (e.g., the anode collector 121, the cathode collector 122, the set of anode fins 132, the electrolyte film 140, the interdigitated cathode 150, and/or the region of the substrate no) into a first coin cell case element 171 electrically coupled to the anode collector 121; and sealing a second coin cell case element 172 over the first coin cell case element 171 to enclose the battery cell 102 and thus form a coin-cell battery. For example, the cathode trace and the anode trace can be electrically coupled to positive and negative coin cell case elements 171, 172, respectively—such as via soldering or with conductive paste—and these coin cell case elements 171,172 are closed and sealed to form a coin cell battery.

In another implementation, a non-porous, rigid capacitance glass cap (or other non-conductive material) is bonded to the substrate 110 to enclose the anode, the electrolyte, and the cathode, such as by a laser welding (e.g., deep-penetration laser welding). In this implementation, the glass cap can be pre-fabricated with a recess—such as by etching in potassium hydroxide or with hydrofluoric acid—to accommodate these internal battery structures. For example, the glass capacitance may be transparent to a welding laser (e.g., a Nd:YAG (1064 nm, ps pulse) laser. Conversely, the substrate 110 (e.g., polymeric resin filled with glass fiber, or polyimide) may be opaque to the welding laser and may therefore absorb laser energy, locally melt against the glass cap, and thus hermetically seal against the glass cap along a melting zone where the substrate 110 and the glass cap meet. Furthermore, a metal interfacial layer (e.g. copper, aluminum, chromium, titanium) can be patterned on the substrate 110 proximal this melting zone to increase bond strength between the substrate and the glass cap. Therefore, a hermetic bond may be formed between the substrate and the glass cap within a melting zone tens of microns in width, thereby limiting dead space occupied by non-active battery materials and increasing energy density per unit area of substrate within the completed battery assembly.

### 10.1 Battery Cluster

In another implementation, the substrate no, anode coupon 130, anode fins 132, electrolyte, and cathode are fabricated en masse and singulated (or “segmented,” such as by laser-dicing). Each individual battery cell 102 is then: loaded into a first (e.g., lower) coin cell case element 171; wetted with electrolyte; and then sealed with a second (e.g., top) coin cell case element 172.

In a similar implementation, multiple battery cells 102 are fabricated on one substrate 110 and then assembled or folded to form a “stack” of battery cells 102, which are then loaded into a coin cell package 170 to form a coin cell battery. For example, the method S100 can include: fabricating a first anode collector 121 in a first region of a conductive film 120 over a substrate 110 in Block S110; fabricating a second anode collector 121 in a second region of the conductive film 120 over the substrate 110 in Block S110; fabricating a first cathode collector 122, interdigitated with the first anode collector 121, in the first region of the conductive film 120 in Block S112; fabricating a second cathode collector 122, interdigitated with the second anode collector 121, in the second region of the conductive film 120 in Block S112; forming a first anode coupon 130 of an anode material over the first region of the conductive film 120 in Block S120; forming a second anode coupon 130 of anode material over the second region of the conductive film 120 in Block S120; ablating the first anode coupon 130 to selectively remove segments of the anode material from the first anode coupon 130 and to form a first set of anode fins 132 over the first anode collector 121 in Block S130; ablating the second anode coupon 130 to selectively remove segments of the anode material from the second anode coupon 130 and to form a second set of anode fins 132 over the second anode collector 121 in Block S130; forming a first electrolyte film 140 across the first set of anode fins 132 in Block S140; forming a second electrolyte film 140 across the second set of anode fins 132 in Block S140; depositing a cathode material over the first cathode collector 122 and between adjacent anode fins 132 in the first set of anode fins 132 to form a first interdigitated cathode 150 in Block S150; and depositing the cathode material over the second cathode collector 122 and between adjacent anode fins 132 in the second set of anode fins 132 to form a second interdigitated cathode 150 in Block S150. In this example, the method S100 can also include: stacking the first segment of the substrate 110 containing the first region of the conductive film 120 and a second segment of the substrate 110 containing the second region of the conductive film 120 to form an electrode stack; wetting the first and second electrolyte films 140 with solvated ions to activate the electrolyte film 140; loading the electrode stack into a first coin cell case element 171 (e.g., with the first coin cell case element 171 electrically coupled to the first anode collector 121); and sealing the second coin cell case element 172 over the first coin cell case element 171 to enclose the electrode stack (e.g., with the second coin cell case element 172 electrically coupled to the second cathode collector 122) and to form a multi-cell battery.

In the foregoing example, the method S100 can further include fabricating a bridge 114 (or a “branch,” a “scaffold”) in a third region of the conductive film 120 extending between the first region and the second region such that the bridge 114 connects the first cathode collector 122 and the second anode collector 121 in series (or connects the first cathode collector 122 and the second cathode collector 122 in parallel, etc.), as show in FIG. 5. Accordingly, the method S100 can include folding the substrate 110 across the bridge 114 to overlay the second segment of the substrate 110 over the first segment of the substrate no (with the bottom layers of the first and second segments of the substrate no abutting) before the pair of battery cells 102 are loaded into the coin cell package 170.

### 11. Variation: Integrated PCB Battery

In one variation shown in FIG. 1, the substrate 110 extends beyond the footprint of the battery and includes traces and pads for additional passive and/or active electrical components 184 powered by the integrated battery.

In one implementation, the anode trace is fabricated in an isolated region (e.g., one corner covering less than 50% of the surface area) of the substrate 110 in Block S110 with the remaining conductive film 120 left intact across this side of the substrate 110. The anode, electrolyte, and cathode are then fabricated over this isolated region of the substrate 110, and the resulting battery is (hermetically-) sealed over this isolated region of the substrate 110, such as with: a glass cap laser welded according to the method S100s and techniques described above; by thermally-bonding a polymeric (e.g., chemically-resistant Polyether ether ketone) to the substrate 110 over this battery; or by bonding and interdiffusing a glass, metallic or ceramic cap 160 to the substrate 110 over this battery.

### 11.1 Battery Fabrication Followed by Trace Fabrication

The conductive film 120 across the exposed region of the substrate 110 beyond the battery is then further processed (e.g., etched via stereolithography): to remove conductive material around the perimeter of the battery and thus to form the cathode trace in Block S112; to form a ground trace extending outwardly from the anode trace under the battery; to form a power supply (or “Vcc”) trace extending outwardly from the cathode trace under the battery; and to form a network of high- and low-voltage traces and component pads. Solder paste can then be applied to these component pads, electrical components 184 (e.g., battery charging circuit components, a microcontroller, a dock, and a sensor) can be placed into solder paste on their respective component pads, and the entire assembly—including the battery—can be passed through a reflow oven to reflow the solder paste and complete assembly of this PCB with the integrated battery. This PCB can then be installed in a housing to form a complete electronic device with integrated (rechargeable) battery.

### 11.2 Concurrent Battery and Trace Fabrication

In a similar implementation shown in FIG. 1, the anode trace, cathode trace, ground trace, power supply trace, network of high- and low-voltage traces, and constellation of component pads are first fabricated (e.g., etched via stereolithography) in the conductive film 120 on the substrate 110. A region of the substrate 110 outside of the anode and cathode traces is then masked; the anode, electrolyte, and cathode are fabricated in Blocks S120, S130, S140, and S150 as described above; and the resulting battery is sealed over the substrate 110, such as described above. The mask is then removed from the substrate 110; solder paste is applied to the component pads now exposed across the substrate 110; components are placed into solder paste on their respective component pads; and the entire assembly—including the battery—is passed through a reflow oven to reflow the solder paste and complete assembly of this PCB with the integrated battery.

In this implementation, the method S100 can include concurrently etching the anode collector 121 and the cathode collector 122 in the region of the conductive film 120 over the PCB; and etching the conductive film 120 to form a set of traces of an electrical circuit 180—extending from the anode collector 121 and the cathode collector 122—on the PCB in Block S130. More specifically, in this example, the method S100 can include concurrently fabricating: the anode collector 121 in the region of the conductive layer of the PCB; and a set of traces of the electrical circuit 180—extending from the anode collector 121 and the cathode collector 122—on the printed circuit board. A cap 160 (e.g., a transparent glass cap bonded via laser welding) can then be applied over the region of the substrate 110 to enclose the battery formed by the anode collector 121, the cathode collector 122, the set of anode fins 132, the electrolyte film 140, and the interdigitated cathode 150. A set of passive electrical components 184 and/or integrated circuits can then be assembled onto the set of traces to complete the electrical circuit 180. For example, the electrical circuit 180 can thus form a battery charging circuit configured to charge the battery when connected to a power supply. Alternatively, the electrical circuit 180 can be powered by the battery thus formed by the anode collector 121, the cathode collector 122, the set of anode fins 132, the electrolyte film 140, and the interdigitated cathode 150.

### 11.3 Circuit Assembly Followed by Battery Fabrication

Alternatively, the traces can be fabricated and the electrical components 184 can be installed on the substrate 110 prior to fabrication of the battery according to the process described above.

Thus, in this variation, the method S100 can be executed to fabricate a battery directly onto a PCB, which can then be assembled with additional electrical components 184 to form a complete electronic device with integrated (rechargeable) battery.

### 11.1 Integrated Battery System

Therefore, in this variation, the method S100 can be executed to produce a battery system 100 that includes: a substrate 110; a conductive layer arranged over the substrate 110; a first collector 121 comprising a set of conductive vanes fabricated in a region of the conductive layer; a first set of electrode fins arranged over the set of conductive vanes of the first collector 121 and formed via ablation of a coupon of a first electrode material cast over the region of the conductive layer; an electrolyte film 140 extending across the first set of electrode fins; a second electrode of a second electrode material formed over the electrolyte film 140 and extending between the first set of electrode fins; and a second collector 122 coupled to the second electrode.

In one implementation, the substrate 110 includes a printed circuit board (e.g., a flexible or rigid PCB), and the conductive layer includes a metallic film (e.g., copper, aluminum) applied across the top layer of the printed circuit board.

In this implementation, the first set of electrode fins can define an anode. In this implementation, an anode material can be cast over the region of the conductive layer to form the coupon, and the first set of electrode fins can be formed via laser-machining of the coupon. For example, the anode material can include: between 88% and 92% (e.g., 90%) by weight active material predominantly between 5 microns and 10 microns in maximal dimension; between 7% and 9% (e.g., 8%) by weight conductive agent approximately 100 nanometers in maximal dimension; and between 1% and 3% (e.g., 2%) by weight polymer binder.

In this implementation, the second collector 122 (e.g., a cathode collector 122) defines a second set of conductive vanes (e.g., electrical traces on a PCB substrate 110)—interdigitated between and electrically isolated from the first set of conductive vanes (e.g., electrical traces on a PCB substrate 110)—fabricated in the region of the conductive layer. In this implementation, the second electrode (e.g., a cathode) can be fabricated in a second electrode material (e.g., a cathode material) cast over the electrolyte film 140, extending between the first set of electrode fins (e.g., anode fins 132), and extending down to the second set of conductive vanes on the substrate 110.

Therefore, in this implementation, the first collector 121 (e.g., the anode collector 121), the first set of electrode fins (e.g., the anode), the electrolyte film 140, the second electrode (e.g., the cathode), and the second collector 122 (e.g., the cathode collector 122) can form a battery integrated over the substrate 110.

In this implementation, the battery system 100 can also include a set of traces of an electrical circuit 180: fabricated in the conductive layer on the printed circuit board; and extending from the first collector 121 and the second collector 122 to a second region of the substrate 110, such as an adjacent region on the same side of the substrate 110 as the battery and/or to an opposite side of the substrate 110. Furthermore, a set of electrical components 184 (e.g., passive component, integrated circuits) can be assembled onto the set of traces to complete the electrical circuit 180, which may be powered by the battery or which may function as a charging circuit configured to recharge the battery. The battery system 100 can also include an electrically-insulative material 160 (e.g., a prefabricated glass cap) arranged over the battery and cooperating with the substrate 110 to encapsulate the battery.

Accordingly, the battery system 100—including the integrated and encapsulated battery and the electrical circuit 180—can form a complete and self-powered electrical circuit 180 fabricated on a common substrate 110. The footprint of the collectors—and therefore the battery—can also be expanded across the region of substrate 110 to enable a thinner battery without substantially reducing capacity of the battery in order to yield a thinner overall electrical circuit 180. Alternatively, the footprint of the collectors—and therefore the battery—can also be reduced within a region of substrate 110 and the first electrode can be fabricated with greater height to achieve sufficient battery capacity within a smaller overall footprint of the electrical circuit 180. Furthermore, because the battery is fabricated directly on the substrate 110 via lithography, casting, and ablation, the battery footprint, thickness, and capacity can be designed and fabricated as an integrated component of the electrical circuit 180 with minimal or no custom tooling, thereby limiting cost of unique or low-production battery geometries and enabling greater capacity per unit volume of the battery. Similarly, the base of the substrate 110 forms a wall of the battery, thereby eliminating a need for additional battery packaging that may otherwise increase the overall size of the electrical circuit 180 given the same battery capacity.

### 12. Variation: Vertical Battery

In another variation, the method S100 is executed to fabricate a battery with vertically-interdigitated anode and cathode fins.

### 12.1 Substrate

In this variation, the substrate no can include a conductive or dielectric substrate no such as described above.

In another implementation, the substrate no includes a metal film, such as a 300-micron-thick copper or aluminum foil.

In yet another implementation, the substrate no includes a conductive metallic mesh, such as a copper or aluminum screen with an open area of 50% and maximum width opening less than half the width of an anode fin. In this implementation, the anode material can be fabricated over the mesh and can penetrate openings in the mesh such that the mesh mechanically retains the resulting anode fins 132.

In another implementation, the substrate 110 includes a case element of a coin cell package 170—such as a negative coin cell case element—and the anode, electrolyte, and cathode are fabricated according to the method S100 directly onto the coin cell case element. Alternatively, the anode fins 132, electrolyte, and cathode can be fabricated en masse over a common substrate 110 and then singulated (e.g., by laser-dicing). Each individual battery cell 102 is then: loaded into a first coin cell case element 171; wetted with electrolyte; and then sealed with a second (e.g., top) coin cell case element 172.

### 12.2 Anode Coupon and Anode Fin Fabrication

The anode coupon 130 can then be formed over the substrate 110 and laser-machined to form the array of anode fins 132, such as described above. For example, in this variation, the anode coupon 130 can be machined to yield: an array of elongated, parallel anode fins 132; a first column extending perpendicular to and connecting the array of anode fins 132 to form a first “wall” along a first end of the anode; and a second column extending perpendicular to and connecting the array of anode fins 132 to form a second wall along an opposite end of the anode. In this variation, valleys between these anode fins 132 can also be machined to a depth offset above the anode trace such that the anode trace and the adjacent region of the substrate 110 are fully capped by the anode.

### 12.3 Electrode Fin Machining

The anode can then be coated with electrolyte material to form a rigid electrolyte, as described above.

### 12.4 Cathode

Cathode material can then be floated, deposited, pressed, or otherwise applied over the electrolyte inside of the walls and outermost fins of the anode to form cathode fins that extend downward to fill valleys between adjacent anode fins 132. For example, a concentrated slurry of cathode material (e.g., 30-70% solids by mass; 70-30% solvent by mass) can be pressed into valleys between electrolyte-coated anode fins 132 to achieve high pack density and short drying times for the cathode.

### 12.5 Cathode Current Collector

A cathode current collector is then installed over the cathode.

In one implementation, a metallic film (e.g., an aluminum foil) is bounded over the substrate no to form the cathode current collector.

In another implementation in which the substrate no includes or is installed in a negative coin cell case element 171, an opposing positive coin cell case element 172 can be installed over the negative coin cell case element 171 to form the cathode collector 122 and to complete the battery. For example, the anode fins 132, electrolyte, and cathode: can be fabricated en masse over a common substrate 110 to form an array of battery cells 102 taller (e.g., by 50 microns) than an internal height of a coin cell package 170; and then singulated (e.g., by laser-dicing). Each individual battery cell 102 is then: loaded into a first coin cell case element 171; wetted with electrolyte; and enclosed with a second (e.g., top) coin cell case element 172. The first and second coin cell case elements 171, 172 are then compressed and sealed to compressed the anode and cathode and thus maintain electrical contact between the anode and the first coin cell case element 171 and between the cathode and the second coin cell case element 172.

In another implementation in which the method S100 is executed to form an integrated battery—with vertically-interdigitated anode and cathode fins—over a PCB-type substrate 110, a first end of a conductive metal (e.g., stainless steel) tongue is soldered (or otherwise bonded) to a power supply trace on the PCB with an opposing end of the tongue sprung against the cathode in order to electrically couple the cathode to the power supply trace on the PCB. The battery and (a portion of) the tongue can then be encased and sealed in a potting material.

Alternatively, an interconnect can be buried in the substrate no and can contact cathode material—applied over the substrate no—through a via.

However, in this variation, a cathode collector 122 of any other form can be installed over the cathode, and the battery can be packaged in any other way to form a discrete battery or PCB with integrated battery.

### 12. Variation: Curved Battery

In one variation, after fabrication of the set of anode fins 132 over the substrate 110, the substrate 110 is loaded into a mandrel that defines a concave or convex surface curved about a primary axis (e.g., a “C-shaped cavity or boss characterized by a uniform radius along its length) such that: the long axes of the anode fins 132 extending approximately parallel to the primary axis of the mandrel; and the substrate 110 bends to fit against the mandrel. The foregoing process is then executed to apply the electrolyte film 140 over the anode fins, to fabricate the cathode 150, and to enclose the resulting battery—which now defines a curved cross-section according to the curved cross-section of the mandrel. In this variation, anode fins can be fabricated with minimal draft (e.g., less than 2°) when configured for loading onto a mandrel that defines a convex boss in order to maximize anode fin side and reduce a gap between the anode fins 132 and the cathode 150 in the resulting curved battery. Conversely, anode fins can be fabricated with draft (e.g., 8°, 22°) inversely proportional to the radius of a mandrel when configured for loading onto the mandrel that defines a concave cavity boss in order to achieve a consistent gap between the anode fins 132 and the cathode 150 along the heights of these anode fins in the resulting curved battery.

Alternatively, in this variation, the substrate no can be loaded into the mandrel after fabrication of the set of anode fins 132 over the substrate 110 and after application of the electrolyte film 140 over the anode fins 132. For example, the substrate 110 can be loaded into the mandrel after application of the electrolyte film 140 over the anode fins 132 and before the over the electrolyte film 140 is cured (i.e., hardens) and wetted with solvated ions.

### 14. Inverted Production

In one variation, Blocks of the method S100 are similarly executed to: fabricate a cathode current collector in a region of a conductive film 120 over a substrate 110 in Block S110; fabricate an anode current collector, interdigitated with the cathode current collector, in the region of the conductive film 120 in Block S112; form a cathode coupon of cathode material over the region of the conductive film 120 in Block S120; ablate the cathode coupon to selectively remove cathode material from the cathode coupon and form a set of cathode fins over the cathode collector 122 in Block S130; form an electrolyte film 140 across the set of cathode fins in Block S140; and deposit an anode material over the anode collector 121 and between adjacent cathode fins in the set of cathode fins to form an interdigitated anode in Block S150.

In particular, in this variation, the foregoing methods and techniques can be executed to first create a cathode coupon and cathode fins, to coat the cathode fins with electrolyte, and to fill the voids between cathode fins with anode material to form a battery. The resulting battery can then be housed and sealed as described above.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for forming a battery comprising:
fabricating an anode collector in a region of a conductive film over a substrate;
fabricating a cathode collector, interdigitated with the anode collector, in the region of the conductive film;
forming an anode coupon of an anode material over the region of the conductive film;
ablating the anode coupon to selectively remove segments of the anode material from the anode coupon and to form a set of anode fins over the anode collector;
forming an electrolyte film across the set of anode fins; and
depositing a cathode material over the cathode collector and between adjacent anode fins in the set of anode fins to form an interdigitated cathode.

2. The method of claim 1, wherein ablating the anode coupon comprises:
scanning a laser beam between adjacent anode fins, in the set of anode fins, over a sequence of tool paths;
focusing the laser beam to a sequence of spot sizes, decreasing in width for each subsequent tool path in the sequence of tool paths, to form the set of anode fins defining tapered geometries exhibiting positive draft over the substrate; and
scanning the laser beam between adjacent anode fins, in the set of anode fins, to remove anode material around bases of the set of anode fins and to expose the conductive film between adjacent anode fins, in the set of anode fins.

3. The method of claim 1:
wherein fabricating the anode collector comprises etching the anode collector in the region of the conductive film over the substrate comprising a printed circuit board, the conductive film comprising a top layer of the printed circuit board; and
further comprising etching the conductive film to form a set of traces of an electrical circuit, extending from the anode collector and the cathode collector, on the printed circuit board.

4. The method of claim 3, further comprising:
applying a cap to the region of the substrate to enclose the battery formed by the anode collector, the cathode collector, the set of anode fins, the electrolyte film, and the interdigitated cathode; and
assembling a set of electrical components onto the set of traces to complete the electrical circuit, the electrical circuit powered by the battery.

5. The method of claim 4, wherein applying the cap to the region of the substrate comprises laser-welding a glass cap to the substrate about the anode collector to enclose the battery.

6. The method of claim 1:
wherein fabricating the anode collector comprises fabricating the anode collector in the region of the conductive film over the substrate comprising a printed circuit board, the conductive film comprising a layer of the printed circuit board; and
further comprising:
etching the conductive film to form a set of traces of an electrical circuit, extending from the anode collector and the cathode collector, on the printed circuit board;
applying a cap to the region of the substrate to enclose the battery formed by the anode collector, the cathode collector, the set of anode fins, the electrolyte film, and the interdigitated cathode; and
assembling a set of passive electrical components and integrated circuits onto the set of traces to complete the electrical circuit comprising a battery charging circuit configured to charge the battery when connected to a power supply.

7. The method of claim 1, further comprising:
wetting the electrolyte film with solvated ions to activate the electrolyte film;
loading the anode collector, the cathode collector, the set of anode fins, the electrolyte film, and the interdigitated cathode into a first coin cell case element, the first coin cell case element electrically coupled to the anode collector; and
sealing a second coin cell case element over the first coin cell case element to enclose the anode collector, the cathode collector, the set of anode fins, the electrolyte film, and the interdigitated cathode and to form the battery.

8. The method of claim 7:
further comprising:
fabricating a second anode collector in a second region of the conductive film over the substrate;
fabricating a second cathode collector, interdigitated with the second anode collector, in the second region of the conductive film;
forming a second anode coupon of anode material over the second region of the conductive film;
ablating the second anode coupon to selectively remove segments of the anode material from the second anode coupon and to form a second set of anode fins over the second anode collector;
forming a second electrolyte film across the second set of anode fins;
depositing the cathode material over the second cathode collector and between adjacent anode fins in the second set of anode fins to form a second interdigitated cathode;
stacking a first segment of the substrate comprising the first region of the conductive film and a second segment of the substrate comprising the second region of the conductive film to form an electrode stack; and
wetting the second electrolyte film with solvated ions to activate the electrolyte film;
wherein loading the anode collector, the cathode collector, the set of anode fins, the electrolyte film, and the interdigitated cathode into the first coin cell case element comprises loading the electrode stack into the first coin cell case element; and
wherein sealing the second coin cell case element over the first coin cell case element comprises sealing the second coin cell case element over the first coin cell case element to enclose the electrode stack to form the battery, the second coin cell case element electrically coupled to the second cathode collector.

9. The method of claim 8:
further comprising fabricating a bridge in a third region of the conductive film between the first region and the second region, the bridge connecting the cathode collector and the second anode collector in series; and
wherein stacking the first segment of the substrate and the second segment of the substrate comprises folding the substrate across the bridge to overlay the second segment of the substrate over the first segment of the substrate.

10. The method of claim 1, further comprising:
applying an electrically-insulative material over the substrate to encase and seal the anode collector, the set of anode fins, the electrolyte film, and the interdigitated cathode to form the battery;
fabricating a second anode collector in a second region of the conductive film over the substrate;
fabricating a second cathode collector, interdigitated with the second anode collector, in the second region of the conductive film;
forming a second anode coupon of anode material over the second region of the conductive film;
ablating the second anode coupon to selectively remove segments of the anode material from the second anode coupon and to form a second set of anode fins over the second anode collector;
forming a second electrolyte film across the second set of anode fins;
depositing the cathode material over the second cathode collector and between adjacent anode fins in the second set of anode fins to form a second interdigitated cathode;
applying the electrically-insulative material over the substrate to encase and seal the second anode collector, the second set of anode fins, the second electrolyte film, and the second interdigitated cathode to form a second battery; and
segmenting the substrate to separate the first battery and the second battery.

11. The method of claim 1, wherein forming the electrolyte film across the set of anode fins comprises:
mixing an electrolyte material with a carrier solvent to form an electrolyte slurry;
during a coating process:
discharging the electrolyte slurry from a nozzle toward the set of anode fins;
traversing the nozzle through a range of orientations relative to the substrate to coat the set of anode fins and an exposed region of the substrate with the electrolyte slurry approximating a consistent thickness; and
ultrasonically agitating the substrate relative to the nozzle;
heating the substrate to remove excess carrier solvent from the electrolyte slurry and form the electrolyte film across the set of anode fins and the exposed region of the substrate;
exposing the electrolyte film to radiation to cure the electrolyte film defining a continuous, rigid, thin-film, porous electrolyte across surfaces of the set of anode fins and the substrate; and
wetting the electrolyte film with solvated ions.

12. The method of claim 1, wherein forming the electrolyte film across the set of anode fins comprises:
filling valleys between adjacent anode fins in the set of anode fills with an electrolyte material;
ablating the electrolyte material to remove excess electrolyte material from around the set of anode fins and the substrate to render the electrolyte film approximating a consistent thickness across the set of anode fins; and
wetting the electrolyte film with solvated ions.

13. The method of claim 1, wherein forming the anode coupon comprises:
applying a polymer film about the region of the conductive film to form an anode coupon mask;
mixing the anode material with a solvent to form an anode slurry;
applying the anode slurry across the anode coupon mask and exposed regions of the conductive film;
drying the anode slurry to form the anode coupon; and
following formation of the electrolyte film across the set of anode fins, removing the anode coupon mask from the conductive film, the anode coupon mask masking a second region of the substrate, adjacent the region of the conductive film, from swarf moving off of the anode coupon during ablation.

14. The method of claim 1:
wherein forming the anode coupon comprises forming the anode coupon over the region of the conductive film comprising a continuous conductive layer over the substrate;
wherein ablating the anode coupon comprises laser-machining the anode coupon to remove anode material, from a top of the anode coupon down to the continuous conductive layer, about bases of the set of anode fins; and
wherein fabricating the anode collector and fabricating the cathode collector comprises laser-machining the continuous conductive layer down to the substrate around bases of the set of anode fins to conductively isolate the anode collector, located under the set of anode fins, from the cathode collector, extending between adjacent pairs of anode fins in the set of anode fins.

15. The method of claim 1:
wherein fabricating the anode collector comprises fabricating the anode collector over the substrate defining a rectangular structure and a primary bending axis parallel to a short side of the rectangular structure, the anode collector comprising a set of parallel vanes extending parallel to the short side of the rectangular structure; and
wherein ablating the anode coupon comprises fabricating the set of anode fins over the set of parallel vanes and extending parallel to the short side of the rectangular structure.

16. A method for forming a battery comprising:
fabricating a first collector in a region of a conductive film over a substrate;
fabricating a second collector, interdigitated with the first collector, in the region of the conductive film;
forming a first electrode coupon of a first electrode material over the region of the conductive film;
ablating the first electrode coupon to selectively remove segments of the first electrode material from the first electrode coupon and to form a first set of electrode fins over the first collector;
forming an electrolyte film across the first set of electrode fins; and
depositing a second electrode material over the second collector and between adjacent electrode fins in the first set of electrode fins to form an interdigitated second electrode.

17. A battery system comprising:
a substrate;
a conductive layer arranged over the substrate;
a first collector comprising a set of conductive vanes fabricated in a region of the conductive layer;
a first set of electrode fins arranged over the set of conductive vanes of the first collector and formed via ablation of a coupon of a first electrode material cast over the region of the conductive layer;
an electrolyte film extending across the first set of electrode fins;
a second electrode of a second electrode material formed over the electrolyte film and extending between the first set of electrode fins; and
a second collector coupled to the second electrode.

18. The battery system of claim 17:
wherein the second collector comprises a second set of conductive vanes, interdigitated between and electrically isolated from the first set of conductive vanes, fabricated in the region of the conductive layer; and
wherein the second electrode comprises the second electrode material cast over the electrolyte film, extending between the first set of electrode fins, and extending down to the second set of conductive vanes.

19. The battery system of claim 17, wherein the first set of electrode fins:
define an anode;
comprise:
between 88% and 92% by weight active material predominantly between 5 microns and 10 microns in maximal dimension;
between 7% and 9% by weight conductive agent approximately 100 nanometers in maximal dimension; and
between 1% and 3% by weight polymer binder; and
are formed via laser-machining of the coupon cast over the region of the conductive layer.

20. The method of claim 17:
wherein the substrate comprises a printed circuit board;
wherein the first collector, the first set of electrode fins, the electrolyte film, the second electrode, and the second collector form a battery over the substrate; and
further comprising:
a set of traces of an electrical circuit fabricated in the conductive layer on the printed circuit board and extending from the first collector and the second collector to a second region of the substrate;
a set of electrical components assembled onto the set of traces to complete the electrical circuit, the electrical circuit powered by the battery; and
an electrically-insulative material arranged over the battery and cooperating with the substrate to encapsulate the battery.
